(19) United States
(12) Patent Application Publication
(10) Pub. No.: US 2013/0074091 A1
(43) Pub. Date: Mar. 21, 2013

(54) TECHNIQUES FOR ENSURING RESOURCES ACHIEVE PERFORMANCE METRICS IN A MULTI-TENANT STORAGE CONTROLLER

(71) Applicants: Felix Xavier, Bangalore (IN); Umasankar Mukkara, Banagalore (IN)

(72) Inventors: Felix Xavier, Bangalore (IN); Umasankar Mukkara, Banagalore (IN)

(73) Assignee: CLOUDBYTE, INC., SAN MATEO, CA (US)

(21) Appl. No.: 13/622,077

(22) Filed: Sep. 18, 2012

(30) Foreign Application Priority Data
Sep. 20, 2011 (IN) 3255/CHE/2011

(51) Int. Cl. G06F 9/46

(52) U.S. Cl. 718/104

(57) ABSTRACT

Techniques for ensuring performance metrics are met by resources in a multi-tenant storage controller are presented. Each resource of the multi-tenant storage controller is tracked on a per tenant bases. Usage limits are enforced on per resource and per tenant bases for the multi-tenant storage controller.

### RELATED APPLICATIONS

The present application is co-pending with and claims foreign priority to Indian Provisional Patent Application No. 3255/CHE/2011 entitled: “Method and Architecture to Enforce Limit on System Resource Utilization in a Multi-Tenant Storage Environment,” filed with the Indian Patent Office on Sep. 20, 2011, the disclosure of which is incorporated by reference herein in its entirety.

### BACKGROUND

Cloud computing is rapidly changing the Internet into a collection of clouds, which provide a variety of computing resources, storage resources, and, in the future, a variety of resources that are currently unimagined.

Specifically, cloud computing is a technology infrastructure that facilitates: supplementing, consuming, and delivering Information Technology (IT) services. The cloud environment provides elastic provisioning of dynamically scalable virtual services.

A tenant is considered as a subscriber of some amount of storage in the cloud or an application who owns part of the shared storage environment. Multi-tenancy is an architecture where a single instance of software runs on a server, which is serving multiple tenants. In a multi-tenant environment, all tenants and their users consume the service from a same technology platform, sharing all components in the technology stack including the data model, servers, and database layers. Further, in a multi-tenant architecture, the data and configuration is virtually partitioned and each tenant works with a customized virtual application instance.

A multi-tenant storage controller hosts multiple storage tenants. Each tenant needs to be guaranteed with a set of performance parameters in terms of Input/Output Operations Per Second (IOPS), latency, and throughput. To provide such a granular level of a Service Level Agreement (SLA) in the multi-tenant storage systems, all the system resources need to be tightly controlled.

Most commercial storage controllers are not multi-tenanted. Almost all of the storage controllers try to achieve whole system level performance parameters by over-provisioning. Even with over-provisioning, the chance of lower performance from the storage is much higher with the existing technologies. Even with the technologies that provide storage multi-tenancy, these technologies try to provide differential services among the tenants by assigning different priorities to them. This lacks in the following aspects:
1) granular policy control, which is critical in the cloud environment, is not possible;
2) techniques are on a best effort priority adjustment, hence performance parameters are not guaranteed;
3) when the overall system is highly loaded, individual tenants can end up with much lower performance due to locks happening around resource contentions; and
4) the techniques cannot control the spike in resource utilization—these spikes can really make the controller unusable for an extended period of time.

With existing approaches, a storage controller has to control its limited system resources dynamically to account for any changing SLA policy requirements. In today's storage controllers, the control of the resources is monolithic in nature. The resources are not controlled on a per tenant basis.

### SUMMARY

Various embodiments of the invention provide techniques for ensuring resources achieve performance metrics in a multi-tenant storage controller. Specifically, and in one embodiment a method for ensuring performance metrics are achieved in a multi-tenant storage controller is presented.

More particularly and in an embodiment, a resource service is allocated for each resource of a multi-tenant storage controller to each tenant. Next, each tenant identity for each tenant for each resource service used by that tenant is tracked for the multi-tenant storage controller. Finally, a usage limit is enforced on the multi-tenant storage controller for each tenant for each resource service.

### BRIEF DESCRIPTION OF THE DRAWINGS

FIG. 1A is a diagram depicting an architecture for a multi-tenant storage controller, according to embodiments presented herein.

FIG. 1B is a diagram of a task scheduler identified in the architecture of the FIG. 1A, according to embodiments presented herein.

FIG. 1C is a diagram of a disk IO queue manager identified in the architecture of the FIG. 1A, according to embodiments presented herein.

FIG. 1D is a diagram of a file system cache manager identified in the architecture of the FIG. 1A, according to embodiments presented herein.

FIG. 1E is a diagram of a network bandwidth manager identified in the architecture of the FIG. 1A, according to embodiments presented herein.

FIG. 2 is a diagram of a method for ensuring performance metrics are achieved in a multi-tenant storage controller, according to embodiments presented herein.

FIG. 3 is a diagram of another method for ensuring performance metrics are achieved in a multi-tenant storage controller, according to embodiments presented herein.

FIG. 4 is a diagram of a performance metric enforcer system, according to embodiments presented herein.

### DETAILED DESCRIPTION

A “resource” includes a user, service, system, device, directory, data store, groups of users, a file, a file system, combinations and/or collections of these things, etc. A “principal” is a specific type of resource, such as an automated service or user that acquires an identity. As used herein a “principal” may be used synonymously and interchangeably with the term “tenant.”

A “processing environment” defines a set of cooperating computing resources, such as machines (processor and memory-enabled devices), storage, software libraries, software systems, etc. that form a logical computing infrastructure. A “logical computing infrastructure” means that computing resources can be geographically distributed across a network, such as the Internet. So, one computing resource at network site X and be logically combined with another computing resource at network site Y to form a logical processing environment.

The phrases “processing environment,” “cloud processing environment,” “cloud environment,” and the term “cloud” may be used interchangeably and synonymously herein.

Moreover, it is noted that a “cloud” refers to a logical and/or physical processing environment as discussed above.

The techniques presented herein are implemented in machines, such as processor or processor-enabled devices (hardware processors). These machines are configured and programmed to specifically perform the processing of the methods and systems presented herein. Moreover, the methods and systems are implemented and reside within a non-transitory computer-readable storage media or machine-readable storage medium and are processed on the machines configured to perform the methods.

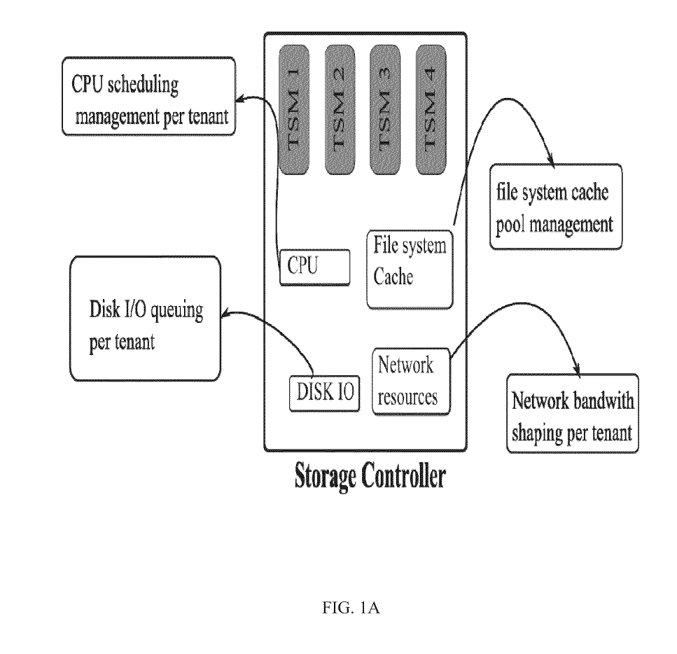

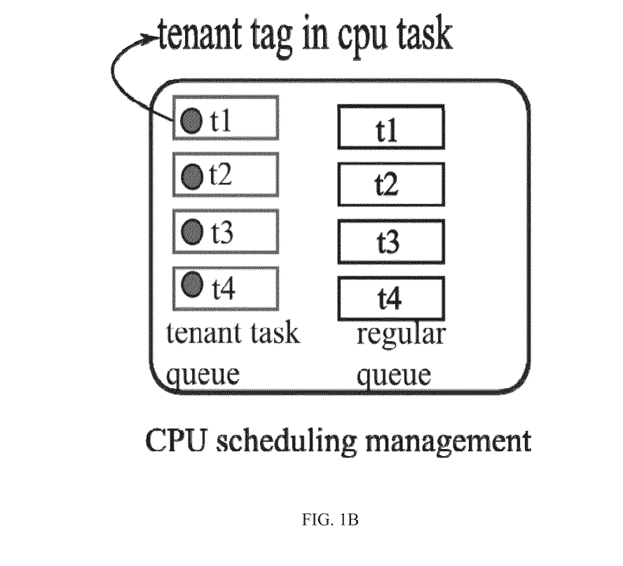

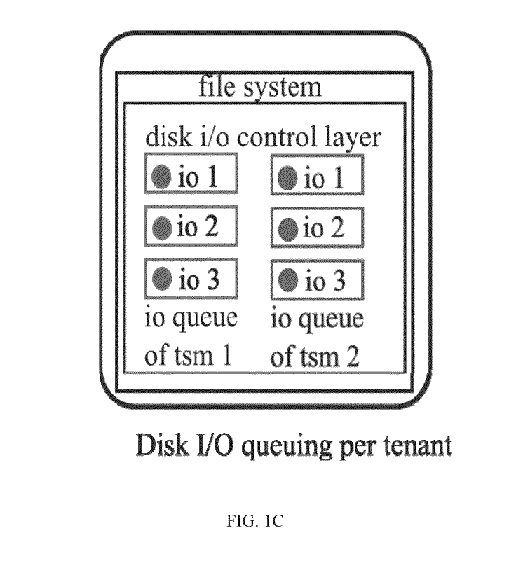

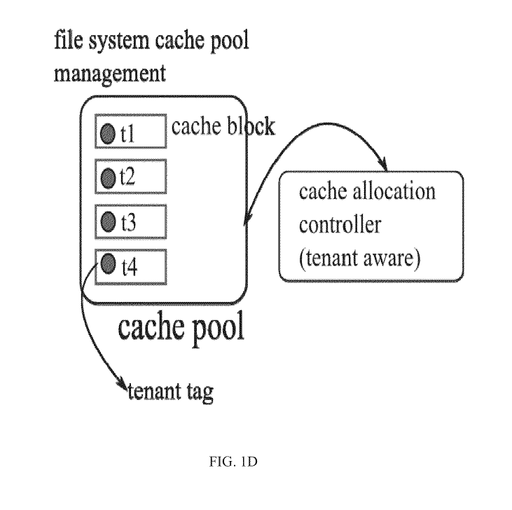

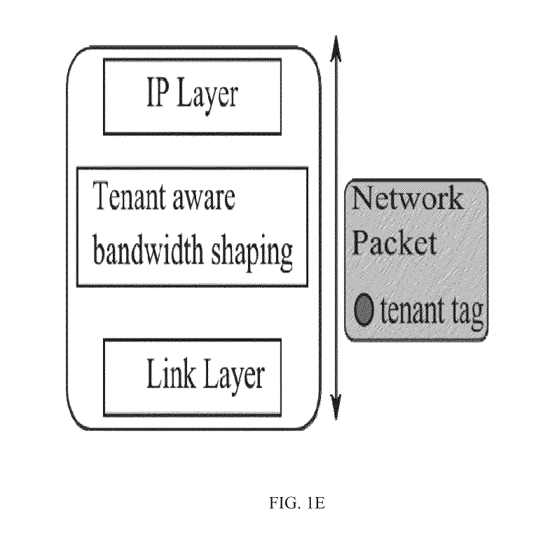

It is within this context that embodiments of the invention are now discussed within the context of the FIGS. 1-4.

FIG. 1A is a diagram depicting an architecture for a multi-tenant storage controller, according to embodiments presented herein. It is noted that the architecture is presented as one example embodiment as other arrangements and elements are possible without departing from the teachings presented herein.

The techniques herein enforce a limit on system resource utilization such as Central Processing Unit (CPU), cache, disk IO (Input/Output), and network bandwidth on a per tenant basis to achieve the configured Service Level Agreement (SLA) policy. Specifically, the techniques herein provide a mechanism to enforce the resource limits in terms of CPU, memory/cache, disk IO and network bandwidth for a given set of performance parameters; and, this can be done for any kind of workload. The embodiments herein provide a technique to tag the resources on a per tenant basis and enforce a desired amount of resources for a given tenant using the tag.

Now referring to the FIG. 1A architecture; embodiments herein define the following techniques:
isolating the components between tenants and minimizing the interaction between these components:
   each tenant has its own instance of application level components hence each tenant does not have the interaction with the other tenants' application level components;
   in the kernel, each tenant has its own set of kernel threads and the threads have very minimum interactions between them;
maintaining the identity of the tenants throughout the storage system:
   each of the processes in the storage system has the tenant identity in a Process Control Block (PCB);
   each of the disk IO requests carries the tag of the tenants;
   each of the buffer caches has the tenant related tag; and
enforcing the calculated parameters for CPU, network bandwidth, disk IO, and memory/cache.

FIG. 1B is a diagram of a task scheduler identified in the architecture of the FIG. 1A, according to embodiments presented herein. Again, the diagram is presented for purposes of illustration and other arrangements are foreseeable without detracting from the teachings presented herein.

A CPU scheduling algorithm is modified in such a way that a group of threads belonging to same tenant gets the calculated amount of a CPU slice within a given window of the time. The following is the processing:
1) a new task queue called tenant task queue is defined in the scheduler;
2) all the tenant related threads/processes gets added to this task queue; and
3) for example if tenant #1 is limited to 10%, tenant #2 is limited 20% and tenant #3 is limited to 15%, the tenant task queue is assigned with a total capacity of 45%, the remaining 55% is open to a general system level task.

FIG. 1C is a diagram of a disk IO queue manager identified in the architecture of the FIG. 1A, according to embodiments presented herein. Again, the diagram is presented for purposes of illustration and other arrangements are foreseeable without detracting from the teachings presented herein.

The disk IO queue manager provides the following processing:
1) a new layer is defined at the bottom of the file system called disk IO control layer;
2) since each IO is tagged for the tenant, a tenant based queue is created;
3) weighting is assigned to each queue based on a calculated disk IO requirement for that tenant;
4) for example if overall disk IO capability of the storage system is 500 IOPS, tenant #1 assigned with 100, tenant #2 assigned with 150 and tenant #3 is assigned with 250—tenant #1 gets the weightage of 20% (100/500), tenant #2 gets the weightage of 30% and tenant #3 gets the weightage of 50%; and
5) in a given window of time say 60 s, it is made sure that each of the tenants gets the calculated value of disk IO that it is owed.

FIG. 1D is a diagram of a file system cache manager identified in the architecture of the FIG. 1A, according to embodiments presented herein. Again, the diagram is presented for purposes of illustration and other arrangements are foreseeable without detracting from the teachings presented herein.

The file system cache manager provides the following the processing:
each tenant maintains the outstanding cache allocation details from the global pool;
whenever there is a buffer cache requirement it comes in the least used buffers from the tenants, which are over-shooting their limit, freed, and given to the new request; and
however, tenants are allowed to consume more than their calculated limit if it is available in the free pool so the precious buffer space is not wasted.

FIG. 1E is a diagram of a network bandwidth manager identified in the architecture of the FIG. 1A, according to embodiments presented herein. Again, the diagram is presented for purposes of illustration and other arrangements are foreseeable without detracting from the teachings presented herein.

The network bandwidth manager includes the following processing:
a tenant tag is assigned and maintained when a packet traverses through the networking subsystem of the storage controller;
a new layer is defined below the Internet Protocol (IP) layer, which does the traffic shaping functionality within storage controller;
each tenant has one pipe and both incoming and outgoing packets are added to the pipe at a rate of configured/calculated throughput for the tenant;
packets are removed from the pipe and are forwarded to the upstream/downstream layers based on their capacity; and
if there is idle networking capacity after allocating the required bandwidth to all the tenants, the idle networking is shared among tenants based on pre-defined algorithm.

As will become more apparent herein and based on the above, the architectures and techniques provide novel benefits, such as, but not limited to:
1. isolation of kernel components between multiple threads and minimizing their interactions;
2. tagging IO transactions within the file system for effective policy enforcement;
3. enforcing CPU scheduling algorithm to limit each tenant with the calculated/configured amount of CPU cycles;
4. sharing the file system cache between multiple tenants with limit of utilization enforced based on calculated/configured value;
5. sharing the disk IO between multiple tenants with limit of utilization enforced based on calculated/configured value; and
6. sharing the network bandwidth between multiple tenants with limit of utilization enforced based on calculated/configured value.

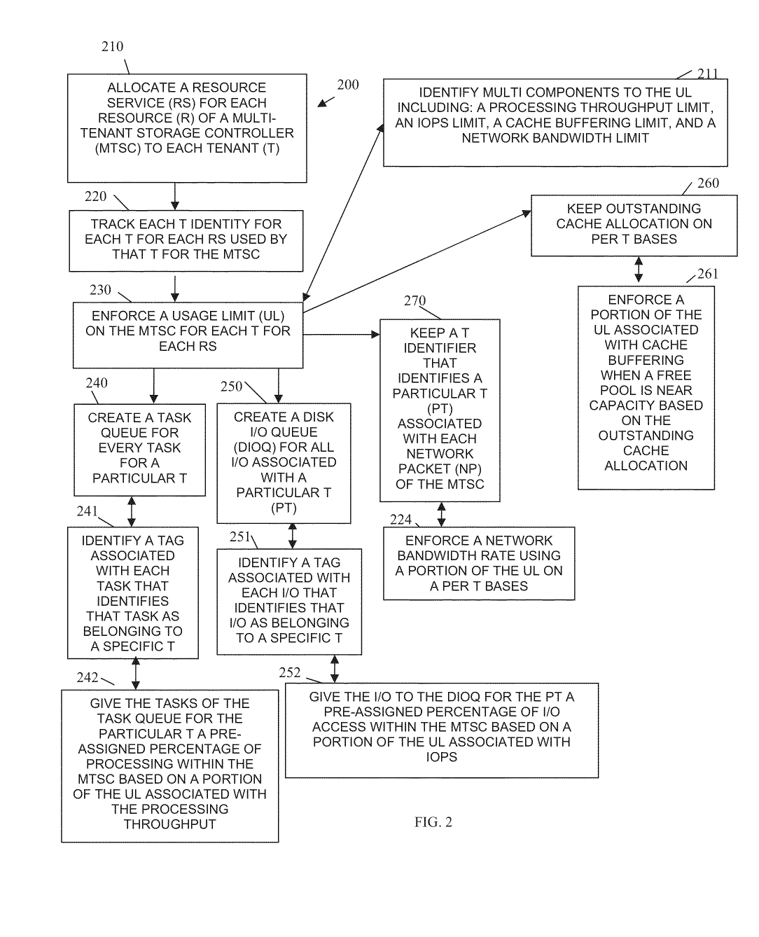

FIG. 2 is a diagram of a method 200 for ensuring performance metrics are achieved in a multi-tenant storage controller, according to embodiments presented herein. The method 200 (herein referred to as “resource enforcement manager”) is implemented, programmed, and resides within a non-transitory machine-readable storage medium that executes on one or more processors of a network. The network may be wired, wireless, or a combination of wired and wireless.

In an embodiment, the resource enforcement manager utilizes the architecture and techniques presented above with respect to the FIGS. 1A-1E.

At 210, the resource enforcement manager allocates a resource service for each resource of a multi-tenant storage controller. This was discussed above with reference to the FIG. 1A. Each resource within the multi-tenant storage controller is broken into a service and each tenant has its own unique instance of that resource service on a per resource bases.

At 220, the resource enforcement manager tracks each tenant identity for each tenant for each resource service used by that tenant for the multi-tenant storage controller. So, each resource service instance is tracked for each tenant to whom it is associated.

At 230, the resource enforcement manager enforces a usage limit on the multi-tenant storage controller for each tenant for each resource service. In other words, each tenant has usage limits for each resource service and each resource service associated with a particular resource of the multi-tenant storage controller.

According to an embodiment, at 231, the resource enforcement manager identifies multiple components to the usage limit (on a per tenant bases) including: a processing throughput limit, an IOPS limit, a cache buffering limit, and a network bandwidth limit.

In an embodiment, at 240, the resource enforcement manager creates a task queue for every task of a particular tenant.

Continuing with the embodiment of 240 and at 241, the resource enforcement manager identifies a tag associated with each task that identifies that task as belonging to a specific tenant.

Still continuing with the embodiment of 241 and at 242, the resource enforcement manager gives the tasks of the task queue for the particular tenant to a pre-assigned percentage of processing within the multi-tenant storage controller based on a portion of the usage limit associated with the processing throughput.

In another case, at 250, the resource enforcement manager creates a disk I/O queue for all I/O associated with a particular tenant.

Continuing with the embodiment of 250 and at 251, the resource enforcement manager identifies a tag associated with each I/O that identifies that I/O as belonging to a specific tenant.

Still continuing with the embodiment of 251 and at 252, the resource enforcement manager gives the I/o of the I/o queue for the particular tenant a pre-assigned percentage of I/O access within the multi-tenant storage controller based on a portion of the usage limit associated with IOPS.

In another situation, at 260, the resource enforcement manager keeps outstanding cache allocation on per tenant bases.

Continuing with the embodiment of 260 and at 261, the resource enforcement manager enforces a portion of the usage limit associated with cache buffering when a free pool is near capacity based on the outstanding cache allocation.

According to an embodiment, at 270, the resource enforcement manager keeps a tenant identifier that identifies a particular tenant associated with each network packet of the multi-tenant storage controller.

Continuing with the embodiment of 270 and at 271, the resource enforcement manager enforces a network bandwidth rate using a portion of the usage limits on per tenant bases.

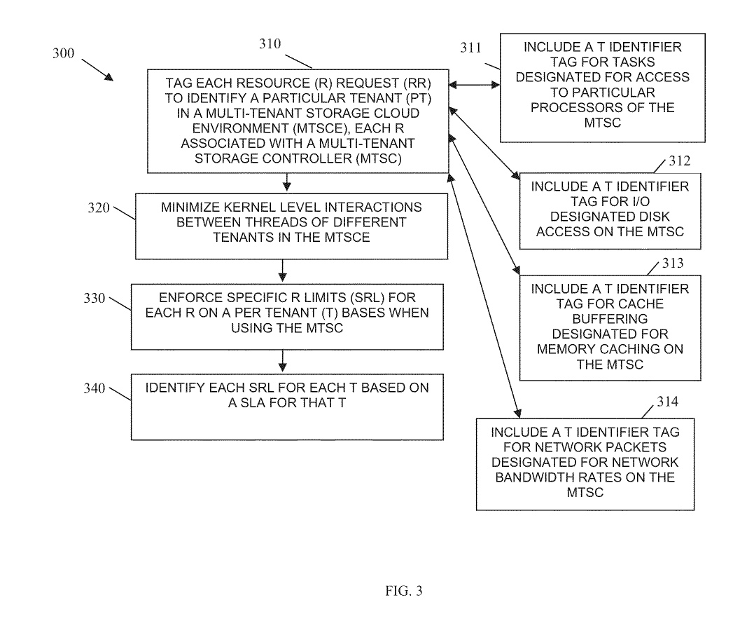

FIG. 3 is a diagram of another method 300 for ensuring performance metrics are achieved in a multi-tenant storage controller, according to embodiments presented herein. The method 300 (herein referred to as “resource enforcement controller”) is implemented, programmed, and resides within a non-transitory machine-readable storage medium that executes on one or more processors of a network. The network may be wired, wireless, or a combination of wired and wireless.

The resource enforcement controller presents another and in some cases enhanced perspective of the resource enforcement manager represented by the method 200 of the FIG. 2. Moreover, the resource enforcement controller is implemented or deployed utilizing the architecture and techniques of the FIGS. 1A-1E.

At 310, the resource enforcement controller tags each resource request to identify a particular tenant in a multi-tenant storage cloud environment (cloud storage environment that services multiple tenants). Each resource associated with a multi-tenant storage controller.

According to an embodiment, at 311, the resource enforcement controller includes a tenant identifier tag for tasks designated for access to particular processors of the multi-tenant storage controller.

In another case, at 312, the resource enforcement controller includes a tenant identifier tag for I/O designated disk access on the multi-tenant storage controller.

In one situation, at 313, the resource enforcement controller includes a tenant identifier tag for cache buffering designated for memory caching on the multi-tenant storage controller.

In yet another case, at 314, the resource enforcement controller includes a tenant identifier tag for network packets designated for network bandwidth rates on the multi-tenant storage controller.

At 320, the resource enforcement controller minimizes kernel level interactions between threads of different tenants in the multi-tenant storage cloud environment. Here, minimize can mean restrict or can mean separating as many tasks as possible within the kernel so they remain within their threads.

At 330, the resource enforcement controller enforces specific resource limits for each resource on per tenant bases when using the multi-tenant storage controller.

According to an embodiment, at 331, the resource enforcement controller identifies each specific resource limit for each tenant based on a specific SLA for that tenant.

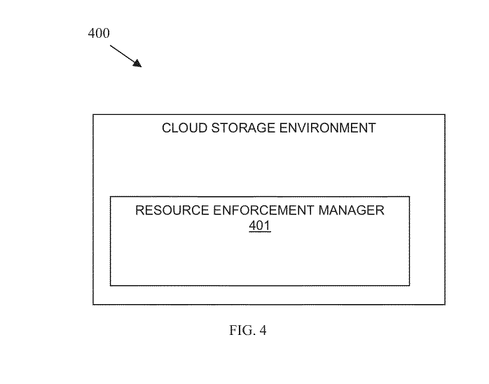

FIG. 4 is a diagram of a performance metric enforcer system 400, according to embodiments presented herein. The components of the performance metric enforcer system 400 are implemented, programmed, and reside within a non-transitory machine-readable storage medium that executes on one or more processors of a network. The network may be wired, wireless, or a combination of wired and wireless.

In an embodiment, the performance metric enforcer system 400 implements, inter alia, the processing associated with the methods 200 and 300 of the FIGS. 2 and 3, respectively using the architecture and techniques provided by the FIGS. 1A-1E.

The performance metric enforcer system 400 includes a cloud storage environment having a resource enforcement manager 401.

The storage controller configuration system 400 includes the cloud storage environment that has one or more processors, memory, and storage.

The memory of the cloud storage environment is configured with the resource enforcement manager 401, which is implemented as executable instructions that process on one or more processors of the cloud storage environment. Example processing associated with the resource enforcement manager 401 was presented above in detail with reference to the FIGS. 1A-1E, 2, and 3.

The resource enforcement manager 401 is configured to track resource usage on per tenant bases for each tenant of a multi-tenant storage controller. Moreover, the resource enforcement manager 401 is configured to enforce usage limits on per resource and per tenant bases for the multi-tenant storage controller.

According to an embodiment, the multi-tenant storage controller includes storage resources for: processing throughput, I/O operations, caching, and network bandwidth.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method implemented in a non-transitory machine-readable storage medium and processed by one or more processors of a machine configured to perform the method, comprising:
allocating, on the machine, a resource service for each resource of a multi-tenant storage controller to each tenant;
tracking, on the machine, each tenant identity for each tenant for each resource service used by that tenant for the multi-tenant storage controller; and
enforcing, on the machine, a usage limit on the multi-tenant storage controller for each tenant for each resource service.

2. The method of claim 1 further comprising, creating, by the machine, a task queue for every task of a particular tenant.

3. The method of claim 2, wherein creating further includes identifying a tag associated with each task that identifies that task as belonging to a specific tenant.

4. The method of claim 3, wherein identifying further includes giving the tasks of the task queue for the particular tenant a pre-assigned percentage of processing within the multi-tenant storage controller based on a portion of the usage limit associated with processing throughput.

5. The method of claim 1 further comprising, creating, by the machine, a disk Input/Output (I/O) queue for all I/O associated with a particular tenant.

6. The method of claim 5, wherein creating further includes identifying a tag associated with each I/O that identifies that I/O as belonging to a specific tenant.

7. The method of claim 6, wherein identifying further includes giving the I/O of the I/O queue for the particular tenant a pre-assigned percentage of I/O access within the multi-tenant storage controller based on a portion of the usage limit associated with Input/Output Operations Per Second.

8. The method of claim 1 further comprising, keeping, by the machine, outstanding cache allocation on a per tenant bases.

9. The method of claim 8, wherein keeping further includes enforcing a portion of the usage limit associated with cache buffering when a free pool is near capacity based on the outstanding cache allocation.

10. The method of claim 1 further comprising, keeping, by the machine, a tenant identifier that identifies a particular tenant associated with each network packet of the multi-tenant storage controller.

11. The method of claim 10, wherein keeping further includes enforcing a network bandwidth rate using a portion of the usage limits on a per tenant bases.

12. The method of claim 1, wherein enforcing further includes identifying multiple components to the usage limit including: a processing throughput limit, an Input/Output Operations Per Second limit, a cache buffering limit, and a network bandwidth limit.

13. A method implemented in a non-transitory machine-readable storage medium and processed by one or more processors of a machine configured to perform the method, comprising:
tagging, on the machine, each resource request to identify a particular tenant in a multi-tenant storage cloud environment, each resource associated with a multi-tenant storage controller;
minimizing, on the machine, kernel level interactions between threads of different tenants in the multi-tenant storage cloud environment; and
enforcing, on the machine, specific resource limits for each resource on a per tenant bases when using the multi-tenant storage controller.

14. The method of claim 13, wherein tagging further includes including a tenant identifier tag for tasks designated for access to particular processors of the multi-tenant storage controller.

15. The method of claim 13, wherein tagging further includes including a tenant identifier tag for Input/Output (I/O) designated disk access on the multi-tenant storage controller.

16. The method of claim 13, wherein tagging further includes including a tenant identifier tag for cache buffering designated for memory caching on the multi-tenant storage controller.

17. The method of claim 13, wherein tagging further includes including a tenant identifier tag for network packets designated for network bandwidth rates on the multi-tenant storage controller.

18. The method of claim 13, wherein enforcing further includes identifying each specific resource limit for each tenant based on a Service Level Agreement (SLA) for that tenant.

19. A system, comprising:
a cloud storage environment having one or more processors, memory, and storage, the cloud storage environment situated in a cloud environment and accessed over a network; and
the memory configured with a resource enforcement manager implemented as executable instructions that process on the one or more processors of the cloud storage environment;
wherein the resource enforcement manager is configured to track resource usage on a per tenant bases for each tenant of a multi-tenant storage controller, and the resource enforcement manager is configured to enforce usage limits on per resource and per tenant bases for the multi-tenant storage controller.

20. The system of claim 19, wherein the multi-tenant storage controller includes storage resources for: processing throughput, Input/Output (I/O) operations, caching, and network bandwidth.
